(19) United States
(12) Patent Application Publication
(10) Pub. No.: US 2026/0309294 A1
(43) Pub. Date: Oct. 8, 2026

(54) COMPONENT FOR A LIGHTING DEVICE FOR A MOTOR VEHICLE, CONNECTION ARRANGEMENT, AND METHOD FOR DISCONNECTING A CONNECTION ARRANGEMENT

(71) Applicant: HELLA GMBH & CO. KGAA, Lippstadt (DE)

(72) Inventors: Odo Karger, Geseke (DE); Sven Kinkel, Borchen (DE); Mathias Niedling, Erfurt (DE)

(21) Appl. No.: 19/639,921

(22) Filed: Apr. 6, 2026

(30) Foreign Application Priority Data
Apr. 8, 2025 (DE) 102025113744.7

(51) Int. Cl. F21S 41/29; F21S 43/27

(52) U.S. Cl. CPC F21S 41/29; F21S 43/27; F21S 2243/00

(57) ABSTRACT

The present invention relates to a component for a lighting device for a motor vehicle, in particular a housing for a headlamp or a rear lamp. The component includes a joining portion for forming a plastic welded connection with a joining portion of a second component, in particular a cover lens. According to the invention, the joining portion of the component has two welding ribs that are spaced apart from one another and extend substantially parallel to one another such that a channel is formed between the welding ribs, which channel is intended to accommodate a solvent.

### CROSS-REFERENCE TO RELATED APPLICATIONS

This application claims the benefit of German Patent Application 10-2025-113-744.7, filed Apr. 8, 2025, the disclosure of which is incorporated by reference in its entirety.

### FIELD OF THE INVENTION

The present invention relates to a component for a lighting device for a motor vehicle, in particular a housing of a headlamp or a rear lamp, an associated connection arrangement, in particular one having a cover lens, and a method for disconnecting such a connection arrangement.

### BACKGROUND OF THE INVENTION

Lighting devices on motor vehicles, such as headlamps or rear lamps, have a housing that is closed on the light exit side by a transparent or translucent cover lens. Typically, the housing and the cover lens are made of thermoplastic materials, and the connection arrangement is formed by means of a plastic welded connection. For example, the cover lens is designed with a circumferentially extending welding rib that is welded in a butt joint or T-joint to a joining portion on the housing, by means of infrared welding, laser welding, or hot gas welding, or other processes.

Disadvantageously, such connection arrangements can no longer be disconnected once installed, meaning that opening the front side of the lighting device—for example, for maintenance or repair purposes—by removing the cover lens is not possible without causing damage. This aspect particularly affects the recyclability of the lighting device at the end of its service life. It would be desirable to recycle the various components in as sorted and efficient a way as possible. This also relates to the separation of the cover lens from the housing, which is typically made of different types of plastic.

### SUMMARY OF THE INVENTION

The object of the present invention is to propose an alternative embodiment of a generic component for a lighting device for a motor vehicle and a connection arrangement based thereon, which is characterized by practical disconnectability, particularly for recycling purposes. This object is achieved by embodiments of a component, a corresponding connection arrangement, and a method for disconnecting such a connection arrangement, as disclosed herein.

The technical teaching of the invention discloses a component for a lighting device for a motor vehicle, in particular a housing of a headlamp or a rear lamp, comprising a joining portion for forming a plastic welded connection with a joining portion of a second component, in particular a cover lens, wherein the joining portion of the component according to the invention has two welding ribs that are spaced apart from one another and extend substantially parallel to one another such that a channel is formed between the welding ribs, which channel is intended to accommodate a solvent.

The invention is based on the concept of filling the channel with a solvent when necessary; under the influence of the solvent, the plastic welded connection and/or the welding ribs soften so that the component can subsequently be disconnected from the connection arrangement with minimal force. Thus, once the service life of the associated lighting device has expired, the component as well as the second component—which previously served as its connection partner—can be separated again and are therefore, in principle, available for a comprehensive recycling; wherein, any contaminants remaining in the region of the joining portion from the previous plastic welded connection must be removed beforehand. Furthermore, this type of disconnectability can also serve as the basis for a (temporary) replacement of the component to ensure the continued operation of the lighting device.

The welding ribs are provided for end-face welding, and the channel is bounded by the flanks of the welding ribs. In particular, the channel width is to be adapted to accommodate the volume of the solvent required for the intended softening. In addition, adaptation to the viscosity of the intended solvent may be necessary. For example, the channel may have a channel width ranging from 0.5 mm to 2 mm and a channel depth ranging from 2 mm to 5 mm.

For example, the joining portion on the component is formed with fully circumferential welding ribs such that the channel is formed between an outer welding rib and an inner welding rib. This is particularly useful in the case of a component designed as a housing, the plastic welded connection of which with a cover lens—as the second component—then provides a front-side sealing of the housing. In this configuration, the channel is sealed against media and isolated from the operating environment so that no contaminants can enter and clog the channel during operation of the associated lighting device.

Preferably, the joining portion includes at least one access zone that has a through-hole or, in particular, a region where the material thickness is reduced in a membrane-like manner, such that the channel can be accessed or opened via the access zone. To inject the solvent—for example, by means of a cannula—the cannula can be inserted into the channel from the outside through the through-hole or through the region where the material thickness has been reduced to form a membrane-like opening. The latter option has the advantage that the channel remains closed during the regular operating life of the associated lighting device. For example, a plurality of access zones may be distributed along a welding rib or along the bottom of the channel. In particular, the channel has a first end portion and a second end portion, wherein the joining portion has an access zone in the vicinity of each of the first and the second end portions. One of these access zones then serves as an inlet for the solvent, while the other access zone serves as an outlet or a vent. This ensures that the channel volume is completely filled with solvent and allows for controlled filling. In a fully enclosed circumferential channel, the first end portion and the second end portion are separated by a thin partition wall within the channel, and the access zones intended for the inflow and outflow of the solvent, respectively, are then arranged adjacent to one another, i.e., on a different side of the partition wall in each case.

The invention further relates to a connection arrangement for a lighting device for a motor vehicle, comprising a first component according to one of the aforementioned embodiments, in particular a housing of a headlamp or a rear lamp, and a second component, in particular a cover lens, wherein a plastic welded connection is formed between the welding ribs and a joining portion of the second component in such a way that the channel is bounded by the joining portion of the second component. Overall, the channel is thus bounded in its width by the opposing flanks of the welding ribs and in its depth by the corresponding surfaces of the joining portions of the two components. In the case of fully circumferential welding ribs, the channel can thus extend entirely within the plastic welded connection, completely isolated from the operating environment.

In an advantageous embodiment of the connection arrangement, the joining portion of the second component also has two spaced-apart welding ribs between which a second channel is formed, wherein the course of the second channel coincides with the course of the channel of the first component, i.e., the channel on the first component and the channel on the second component form two halves of an overall channel. This means that a larger overall volume is available for holding solvents.

For example, the second component has polymethyl methacrylate (PMMA). PMMA is a commonly used plastic for manufacturing cover lenses. Furthermore, the first component may have polycarbonate, acrylonitrile-butadiene-styrene, a mixture of these two types of plastic (PC-ABS blend), or acrylonitrile-styrene-acrylate copolymer (ASA), and may, in particular, form a housing.

The invention also relates to a method for disconnecting a connection arrangement according to any of the aforementioned embodiments, comprising at least the following steps: opening at least one access to the channel, in particular via the access zone in the welding rib; injecting a solvent into the channel via the at least one access; waiting for the weld seams of the plastic welded connection and/or of the welding ribs to soften under the influence of the solvent; and disconnecting the first component from the second component.

The choice of solvent is expediently to be made in accordance with the specific plastics used for the components. Preferably in such a way that the first component is resistant to the solvent. This would be advantageous in particular in the event of an intended replacement of the second component, since the joining portion of the first component would then remain intact for the formation of a new plastic welded connection. In principle, polar solvents such as esters, ketones, or chlorinated hydrocarbons are suitable for softening PMMA.

### BRIEF DESCRIPTION OF THE DRAWINGS

The invention is illustrated below by means of exemplary embodiments with reference to the figures and the associated description. In the drawings:

FIGS. 1a and 1b show sectional views of a first exemplary embodiment of the connection arrangement according to the invention;

FIGS. 2a and 2b show an illustration of the method according to the invention for disconnecting the connection arrangement of the first exemplary embodiment;

FIGS. 3a and 3b show sectional views of a second exemplary embodiment; and

FIGS. 4a and 4b show an illustration of the method according to the invention for disconnecting the connection arrangement of the second exemplary embodiment.

### DETAILED DESCRIPTION

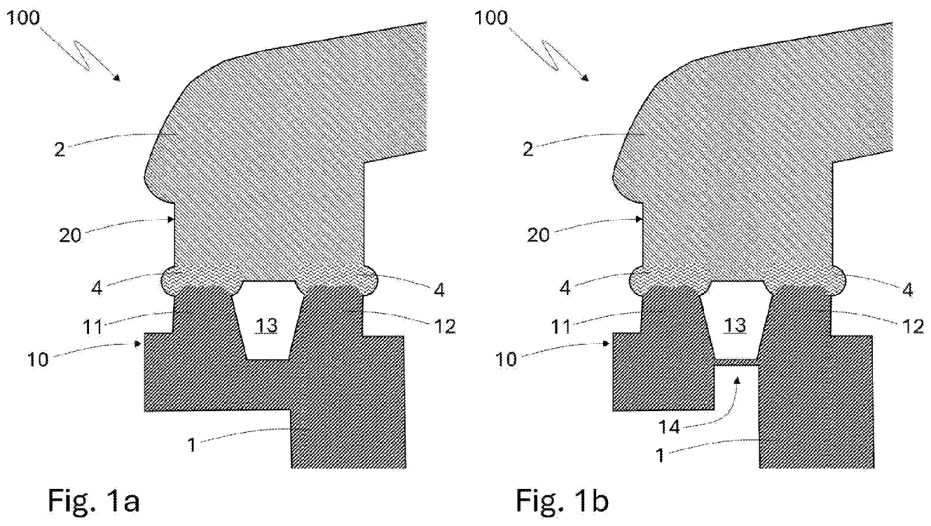

FIG. 1a and FIG. 1b show sectional views of a first exemplary embodiment of the connection arrangement 100 according to the invention, which comprises a first component 1 in the form of a housing of a lighting device for a motor vehicle, as well as a second component 2 in the form of an associated cover lens. In this view, the interior of the housing is in each case on the right side of the drawing, the external operating environment is on the left side of the drawing, and the light exit side of the lighting device is on the side of the upper edge of the drawing.

The first component comprises the joining portion 10 with the outer welding rib 11 and the inner welding rib 12, which are spaced apart from one another and extend substantially parallel to one another, such that the channel 13 is formed between the welding ribs 11, 12. The connection arrangement 100 is held in place by the plastic welded connection with weld seams 4, which is formed between the end faces of the welding ribs 11, 12 and the joining portion 20 of the second component 2, for example, by means of infrared welding.

The section plane in FIG. 1b passes through the access zone 14 in the joining portion 10, wherein the access zone 14 is located on the side of the channel bottom and has a region of membrane-like reduced material thickness. Despite this local reduction in the material cross section, the joining portion 10 in the vicinity of the access zone 14 is preferably media-tight, and the access zone 14 is opened—for example, by piercing or drilling—only for the purpose of injecting solvent into the channel 13.

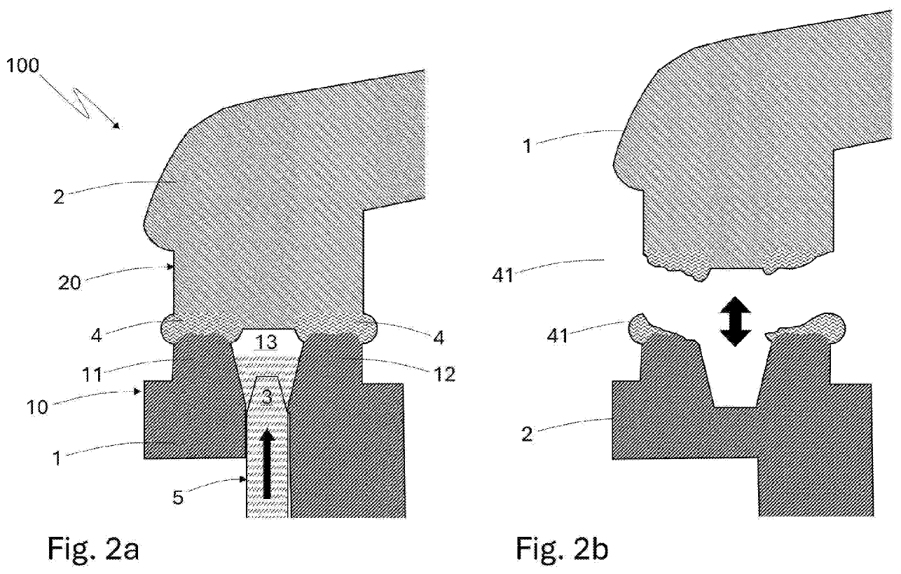

FIG. 2a and FIG. 2b illustrate the steps of the method according to the invention for disconnecting the connection arrangement 100 according to the first exemplary embodiment.

FIG. 2a shows the connection arrangement 100 in the sectional plane shown in FIG. 1b, wherein the region of membrane-like reduced material thickness in the access zone 14 is opened and the cannula 5 passed through it. The liquid solvent 3 is injected into the channel 13 through the cannula 5. The solvent 3 completely fills the channel 13, ensuring that the weld seams 4 are fully wetted on the channel side.

After allowing the weld seams 4 to soften under the influence of the solvent 3, the plastic welded connection compromised in this way, can be completely disconnected, for example, by tensile loading, as shown in FIG. 2b. Once the remaining weld seams 41 have been removed, the components 1, 2, which have been separated from one another in this manner, can be sent for recycling.

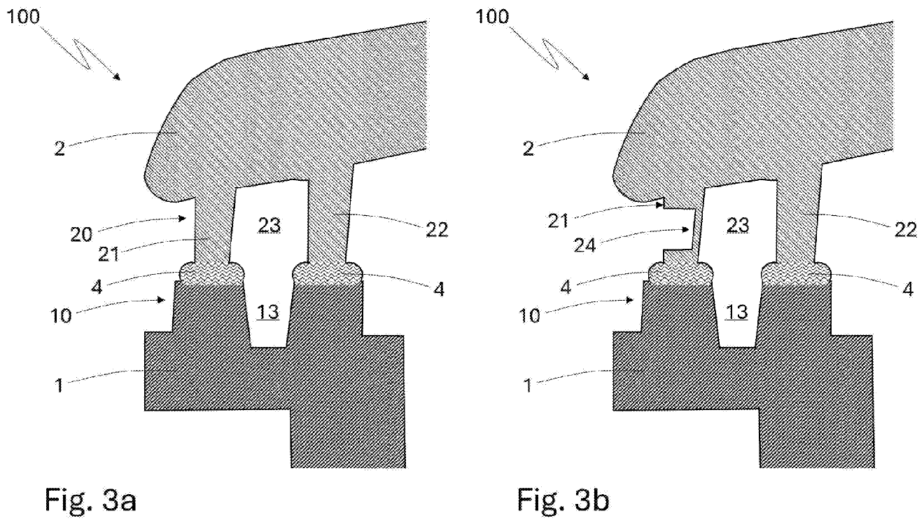

FIG. 3a and FIG. 3b show sectional views of a second exemplary embodiment of the connection arrangement 100 according to the invention. The substantial difference from the first exemplary embodiment is that the second component 2 also has two welding ribs 21, 22, which are spaced apart from one another and extend substantially parallel to each other, so that the second channel 23 is formed between them, the course of which coincides with the course of the channel 13 on the first component 1. This creates a continuous channel with a larger cross section, which, for example, permits the use of a solvent 3 with a higher viscosity. Furthermore, the joining portion 20 of the second component features the access zone 24 in the outer welding rib 21, the wall thickness of which is locally reduced in a membrane-like manner.

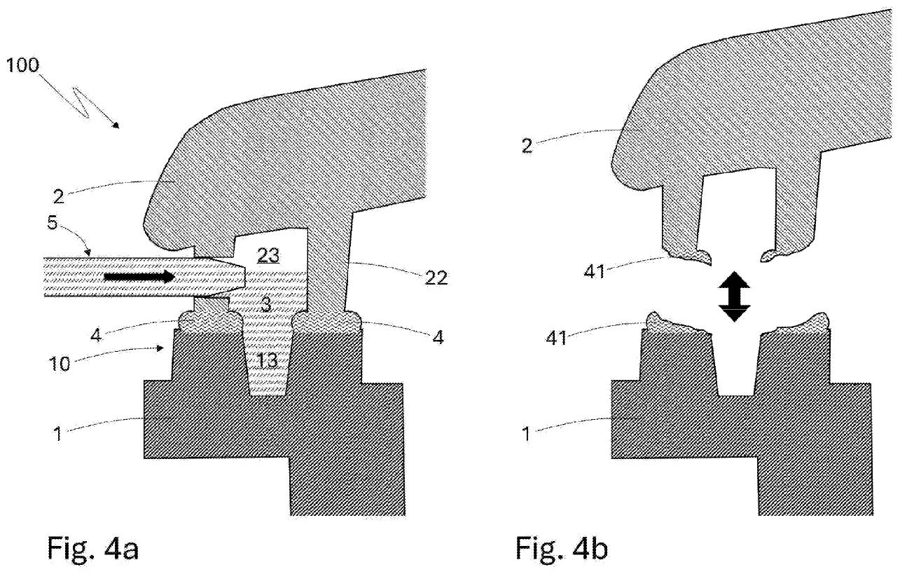

FIG. 4a and FIG. 4b once again illustrate the steps of the method according to the invention for disconnecting the connection arrangement 100, in this case based on the second exemplary embodiment. The access zone 24 on the second component 2, which has been opened to allow insertion of the cannula 5, serves as the inlet for the solvent 3.

### LIST OF REFERENCE SYMBOLS

1 (first) component
10 joining portion
11, 12 welding rib
13 channel
14 access zone
2 second component
20 joining portion
21, 22 welding rib
23 second channel
24 access zone
3 solvent
4 weld seam
41 remaining weld seam
5 cannula
100 connection arrangement

The above description is that of current embodiments of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A component for a lighting device for a motor vehicle, comprising:
a joining portion configured to form a plastic welded connection with a joining portion of a second component, wherein the joining portion includes two welding ribs spaced apart from one another and extending substantially parallel to one another such that a channel is formed between the welding ribs, the channel being configured to accommodate a solvent.

2. The component of claim 1, wherein the joining portion includes fully circumferential welding ribs such that the channel is formed between an outer welding rib and an inner welding rib.

3. The component of claim 1, wherein the joining portion includes at least one access zone having a through-hole or a region of reduced material thickness such that the channel is accessible or openable via the access zone.

4. The component of claim 1, wherein the channel includes a first end portion and a second end portion, and the joining portion includes an access zone in a region of each of the first end portion and the second end portion.

5. A connection arrangement for a lighting device for a motor vehicle, comprising:
a first component according to claim 1; and
a second component having a joining portion, wherein a plastic welded connection is formed between the welding ribs of the first component and the joining portion of the second component such that the channel is bounded by the joining portion of the second component.

6. The connection arrangement of claim 5, wherein the joining portion of the second component includes two welding ribs between which a second channel is formed, and wherein a course of the second channel coincides with a course of the channel of the first component.

7. The connection arrangement of claim 5, wherein the first component comprises polycarbonate, acrylonitrile-butadiene-styrene, a mixture thereof, or acrylonitrile-styrene-acrylate copolymer.

8. The connection arrangement of claim 5, wherein the second component comprises polymethyl methacrylate.

9. A method for disconnecting a connection arrangement according to claim 5, comprising:
opening at least one access to the channel;
injecting a solvent into the channel via the at least one access;
allowing weld seams of the plastic welded connection to soften under the influence of the solvent; and
disconnecting the first component from the second component.

10. The method of claim 9, wherein the first component is resistant to the solvent.
